(19) United States
(12) Patent Application Publication
(10) Pub. No.: US 2026/0078912 A1
(43) Pub. Date: Mar. 19, 2026

(54) SOLAR HEATING SYSTEMS AND METHODS FOR PROVIDING DEMAND RESPONSE ASSISTANCE TO ELECTRIC HEAT PUMPS AND WATER HEATERS

(71) Applicant: DUKE ENERGY CORPORATION, Charlotte, NC (US)

(72) Inventors: David Brian PHILLIPS, Martinsville, IN (US); Steven Patrick HINKEL, Alexandria, KY (US)

(21) Appl. No.: 19/249,652

(22) Filed: Jun. 25, 2025

Related U.S. Application Data
(60) Provisional application No. 63/695,143, filed on Sep. 16, 2024.

(51) Int. Cl. F24D 5/00; F24D 5/12; F24D 17/00; F24D 19/10; F24H 15/168; F24H 15/258; F24H 15/262; F24S 60/30

(52) U.S. Cl. CPC F24D 5/005; F24D 5/12; F24D 17/0068; F24D 19/1093; F24H 15/168; F24H 15/258; F24H 15/262; F24S 60/30; F24D 2200/08; F24D 2200/12; F24D 2200/14; F24D 2200/32

(57) ABSTRACT

A system for providing supplemental heating to a hot water heater and an electric heat pump includes a solar thermal collector, a solar thermal storage vessel, a first water circulating system, a second water circulating system, and a controller. The first water circulating system circulates water between the solar thermal storage vessel and the solar thermal collector. The second water circulating system circulates heated water between the solar thermal storage vessel, the hot water heater, and a heat exchanger associated with the heat pump. The controller is configured to cause water circulation between the hot water heater and the solar thermal storage vessel so as to raise a temperature of water in the solar thermal storage vessel and/or in the hot water heater, and to cause circulation of heated water from the hot water heater to the heat exchanger to provide auxiliary heat for the heat pump.

### RELATED APPLICATION

This application claims the benefit of and priority to U.S. Provisional Ser. No. 63/695,143 filed Sep. 16, 2024, the disclosure of which is incorporated herein by reference as if set forth in its entirety.

### FIELD OF THE INVENTION

The present invention relates generally to electric heat pumps and water heaters and, more particularly, to systems and methods for improving the performance and efficiency of electric heat pumps and water heaters.

### BACKGROUND OF THE INVENTION

Many household and commercial hot water heaters are of a storage type that typically include a vessel/container (i.e., a tank) in which water is kept continuously hot and ready for use. Typically, water is introduced into the tank via a water supply inlet pipe and one or more electrical elements within the tank are selectively operated to heat the water within the tank to a preset temperature. For example, hot water temperatures of 105-120° F. are typically preferred for residential applications. Operation of the one or more electrical elements is controlled by a thermostat that monitors/measures the water temperature within the tank. When the water within the tank is below a desired temperature, the one or more electrical elements are energized to heat the tank and the water therein.

Electrical heat pumps may be utilized as heating systems and as cooling systems for residential and commercial premises. Heat pumps use a refrigeration cycle to move heat energy from a first environment to a second environment. A heat pump can be an attractive source of heating and cooling for an indoor environmental space where the outdoor temperature does not reach extreme lows in the winter. In colder climates, a heat pump may not be sufficient to heat an indoor space without auxiliary heating, such as electric strip heating.

Electric utilities face challenges with consistently satisfying the demand for electricity. Although an electric utility's power plants for generating electricity are typically well-suited for supplying a constant amount of electricity, consumer demand for electricity over the course of a day may vary significantly. Moreover, the onset of extreme cold weather can cause consumer demand for electricity to exceed the capacity of some electric utilities. During such peak demand periods, electric utilities may implement load shedding or demand response (DR) techniques to reduce the amount of energy demanded. Demand response techniques may involve an electric utility directly controlling the heating/cooling systems, as well as other appliances, of its customers in order to reduce their energy demand. Unfortunately, conventional demand response programs may be inconvenient to some electric utility customers

### SUMMARY OF THE INVENTION

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a system for providing supplemental heating to a hot water heater and an electric heat pump at a residential or commercial premise includes a solar thermal collector, a solar thermal storage vessel, a first water circulating system, a second water circulating system, and a controller. The first water circulating system is operable to circulate water between the solar thermal storage vessel and the solar thermal collector. The solar thermal collector is configured to transfer heat to the water circulating between the solar thermal storage vessel and the solar thermal collector in response to receiving solar radiation. The second water circulating system is operable to circulate heated water between the solar thermal storage vessel, the hot water heater, and a heat exchanger within an air supply duct associated with the heat pump. The controller is operably associated with the first and second water circulating systems, the hot water heater, and the heat pump. The controller is configured to control the second water circulating system to cause water circulation between the water heater and the solar thermal storage vessel so as to raise a temperature of water in the solar thermal storage vessel and/or in the water heater, and to cause circulation of heated water from the hot water heater to the heat exchanger to provide auxiliary heat for the heat pump.

In some embodiments, the first water circulating system includes a first pump that is configured to circulate the water between the solar thermal storage vessel and the solar thermal collector. In some embodiments, the second water circulating system includes a second pump and first and second valves. When the first valve is open and the second valve is closed, the water is circulated by the second pump between the hot water heater and the heat exchanger in a supply duct/plenum of the heat pump. When the first valve is closed and the second valve is open, the water is circulated by the second pump between the hot water heater and the solar thermal storage vessel. A battery backup system may be provided that is configured to supply power to the first and second pumps, to the first and second valves, to the controller, and to an air handling unit of the heat pump.

In some embodiments, the controller is configured to control operation of the second water circulating system to cause water circulation between the water heater and the solar thermal storage vessel so as to raise the temperature of the water in the solar thermal storage vessel and/or in the water heater above their respective normal operation temperature set points.

In some embodiments, the heat pump includes at least one auxiliary electric heat strip, and the controller is configured to override use of the at least one auxiliary heat strip by the heat pump and to cause the second water circulating system to circulate heated water from the hot water heater to the heat exchanger to provide auxiliary heat for the heat pump. The controller may be configured to override use of the at least one auxiliary heat strip based on how far the outdoor temperature at the premise is below a balance point of the heat pump.

In some embodiments, the controller is configured to monitor weather forecast data for the location of the residential or commercial premise and, in response to the weather forecast data, control operation of the second water circulating system to cause water circulation between the water heater and the solar thermal storage vessel so as to raise the temperature of the water in the solar thermal storage vessel and in the water heater above their respective normal operation temperature set points.

In some embodiments, the controller is configured to monitor cloud cover and solar insolation data for the location of the residential or commercial premise and, in response to the cloud cover and solar insolation data, control operation of the second water circulating system to cause water circulation between the water heater and the solar thermal storage vessel so as to raise the temperature of the water in the solar thermal storage vessel and in the water heater above their respective normal operation temperature set points.

In some embodiments, the controller is further configured to receive a signal from an electric utility to enter a demand response mode in anticipation of electric grid strain and, in response to receiving the signal, control operation of the second water circulating system to cause water circulation between the water heater and the solar thermal storage vessel so as to raise the temperature of the water in the solar thermal storage vessel and in the water heater above their respective normal operation temperature set points.

According to some embodiments of the present invention, a method of providing supplemental heating to a hot water heater and to an electric heat pump at a residential or commercial premise is provided. The premise includes a solar thermal collector, a solar thermal storage vessel, a first water circulating system operable to circulate water between the solar thermal storage vessel and the solar thermal collector, a second water circulating system operable to circulate heated water between the solar thermal storage vessel, the hot water heater, and a heat exchanger within an air supply duct associated with the heat pump, and a controller operably associated with the first and second water circulating systems, the hot water heater, and the heat pump. The method includes controlling the second water circulating system, via the controller, to cause water circulation between the water heater and the solar thermal storage vessel so as to raise a temperature of water in the solar thermal storage vessel and/or in the water heater above their respective normal operation temperature set points.

In some embodiments, the heat pump includes at least one auxiliary electric heat strip, and wherein during use of the heat pump the method further comprises overriding, via the controller, use of the at least one auxiliary heat strip by the heat pump and causing the second water circulating system to circulate heated water from the hot water heater to the heat exchanger to provide auxiliary heat for the heat pump.

In some embodiments, the second water circulating system includes a second pump and first and second valves. Causing the second water circulating system to circulate heated water from the hot water heater to the heat exchanger to provide auxiliary heat for the heat pump includes the following steps performed by the controller: opening the first valve, closing the second valve, and activating the second pump to cause circulation of heated water between the hot water heater and the heat exchanger in the supply duct/plenum of the heat pump.

In some embodiments, the method further comprises monitoring weather forecast data for the location of the residential or commercial premise, and in response to the weather forecast data, controlling operation of the second water circulating system, via the controller, to cause water circulation between the water heater and the solar thermal storage vessel so as to raise the temperature of the water in the solar thermal storage vessel and in the water heater above their respective normal operation temperature set points.

In some embodiments, the method further comprises monitoring cloud cover and solar insolation data for the location of the residential or commercial premise, and in response to the cloud cover and solar insolation data, controlling operation of the second water circulating system, via the controller, to cause water circulation between the water heater and the solar thermal storage vessel so as to raise the temperature of the water in the solar thermal storage vessel and in the water heater above their respective normal operation temperature set points.

In some embodiments, the method further comprises receiving at the controller a signal from an electric utility to enter a demand response mode, and in response to receiving the signal, controlling operation of the second water circulating system, via the controller, to cause water circulation between the water heater and the solar thermal storage vessel so as to raise the temperature of the water in the solar thermal storage vessel and in the water heater above their respective normal operation temperature set points.

According to other embodiments of the present invention, a system for providing supplemental heating to a water heater and an electric heat pump at a residential or commercial premise includes a solar thermal collector, a solar thermal storage vessel, a first water circulating system operable to circulate water between the solar thermal storage vessel and the solar thermal collector, wherein the solar thermal collector is configured to transfer heat to the water circulating between the solar thermal storage vessel and the solar thermal collector in response to receiving solar radiation, a second water circulating system operable to circulate heated water between the solar thermal storage vessel, the hot water heater, and a heat exchanger within an air supply duct associated with the heat pump, and a controller operably associated with the first and second water circulating systems, the hot water heater, and the heat pump. The controller is configured to receive a signal from an electric utility to enter demand response mode in anticipation of electric grid strain and, in response to receiving the signal, control operation of the second water circulating system to cause water circulation between the water heater and the solar thermal storage vessel so as to raise the temperature of the water in the solar thermal storage vessel and in the water heater above their respective normal operation temperature set points. The system may include a battery backup system configured to supply power to the first and second pumps, to the first and second valves, to the controller, and to an air handling unit of the heat pump

In some embodiments, the heat pump includes at least one auxiliary electric heat strip, and the controller is further configured to override use of the at least one auxiliary heat strip by the heat pump and to cause the second water circulating system to circulate heated water from the hot water heater to the heat exchanger to provide auxiliary heat for the heat pump.

In some embodiments, the controller is further configured to monitor and/or receive weather forecast data for the location of the residential or commercial premise and, in response to the weather forecast data, control operation of the second water circulating system to cause water circulation between the water heater and the solar thermal storage vessel so as to raise the temperature of the water in the solar thermal storage vessel and in the water heater above their respective normal operation temperature set points.

In some embodiments, the controller is further configured to monitor and/or receive cloud cover and solar insolation data for the location of the residential or commercial premise and, in response to the cloud cover and solar insolation data, control operation of the second water circulating system to cause water circulation between the water heater and the solar thermal storage vessel so as to raise the temperature of the water in the solar thermal storage vessel and in the water heater above their respective normal operation temperature set points.

Embodiments of the present invention are advantageous because the system is an easy retrofit to existing heat pump systems and does not require any refrigeration rework. As such, heat pump system manufacturer warranties can remain intact. Additionally, the system provides virtually free hot water for customers in warmer months. Furthermore, the system of the present invention can be implemented using proven and reliable pumps, coils, tanks, and solar thermal panels.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 illustrates a system for providing supplemental heating to electric heat pumps and hot water heaters, according to some embodiments of the present invention.

FIGS. 2-4 are flow charts of operations that are performed by the system of FIG. 1.

FIG. 5 is a block diagram that illustrates details of an exemplary processor and memory that may be utilized to implement the controller of the system of FIG. 1.

### DETAILED DESCRIPTION OF THE INVENTION

The present invention will now be described more fully hereinafter with reference to the accompanying figures, in which embodiments of the present invention are shown. The present invention may, however, be embodied in many different forms and should not be construed as limited to the embodiments set forth herein.

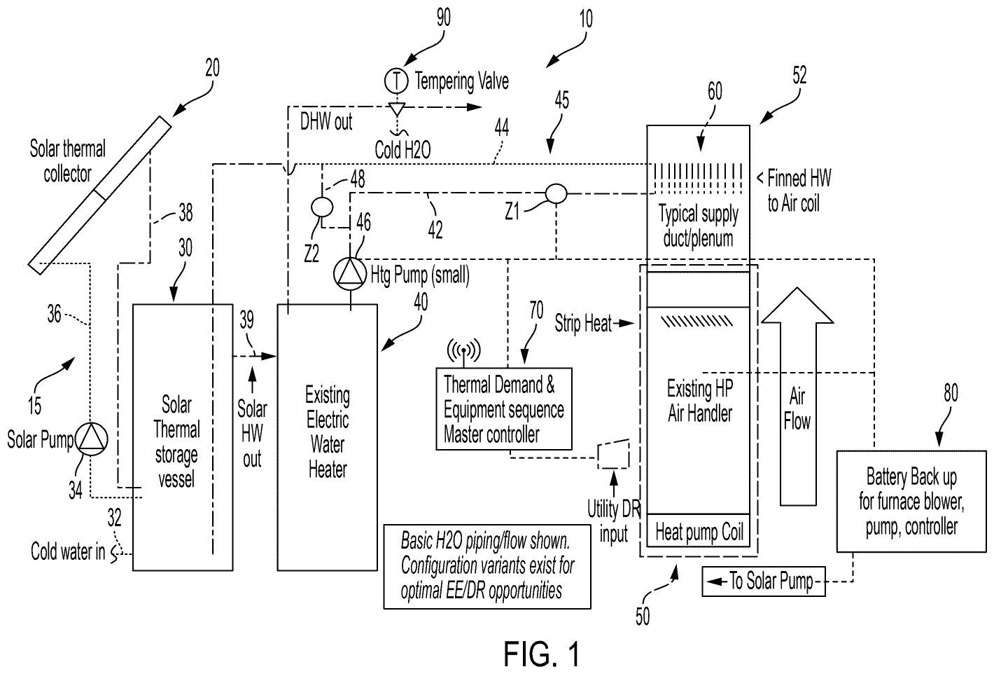

Referring to FIG. 1, a system 10 for reducing electricity demand at a residential or commercial premise (e.g., a house, a building, etc.), according to some embodiments of the present invention, is illustrated. Specifically, the system 10 is configured to reduce electricity demand from an electric hot water heater 40 and an electric heat pump 50 at the residential or commercial premise. The system 10 includes a solar thermal collector 20 operably associated with a solar thermal storage vessel 30. Prior to use of the system 10, the solar thermal storage vessel 30 is filled with water via water inlet 32. The solar thermal storage vessel 30 is in fluid communication with the solar thermal collector 20 via outlet and inlet lines 36, 38, which collectively are referred to as a first water circulating system 15. A pump 34 in the first water circulating system 15 is configured to pump water from the solar thermal storage vessel 30 through outlet line 36 and into the solar thermal collector 20, and then return the heated water to the solar thermal storage vessel 30 via inlet line 38. During the day, and when the sun is shining, water is circulated via pump 34 from the solar thermal storage vessel 30 through the solar collector 20 where the water is heated by the sun and then returned to the solar thermal storage vessel 30. Multiple solar collectors 20 may be utilized and embodiments of the present invention are not limited to a single solar collector 20.

The heated water from the solar thermal storage vessel 30 is utilized to pre-heat water in the hot water heater 40, thereby reducing electricity demand from the hot water heater 40. This may be done on a year-round basis to increase energy usage efficiency of the hot water heater 40.

The solar thermal collector 20 may include an array of thin-walled tubes through which water flows and is heated by the sun. The solar thermal collector 20 may be mounted on a roof or side wall of a residential or commercial structure. In some embodiments, the solar thermal collector 20 may be located adjacent to the structure or even on or near the ground adjacent to the structure. In some embodiments, a separate fluid system may be utilized that is heated via the one or more solar collectors 20 and then passes through a heat exchanger in the solar thermal storage vessel 30 to heat the water in the solar thermal storage vessel 30. Various types of solar thermal collectors may be utilized and embodiments of the present invention are not limited to any particular type of solar thermal collector 20.

The solar thermal storage vessel 30 is in fluid communication with the water heater 40 via a connecting line 39 and provides heated water to the water heater 40 via the connecting line 39. Water flows from the solar thermal storage vessel 30 into the water heater 40 in two modes: 1) when hot water is drawn through the tempering valve 90 for service use, e.g., showers, laundry, etc., cold water is introduced into the solar thermal storage vessel 30 via line 32, thus creating flow through line 39; 2) when water temperature in the solar thermal storage vessel 30 exceeds the water temperature in the water heater 40, valve Z2 opens (with valve Z1 closed) and the pump 46 operates to circulate water via line 48 into the solar thermal storage vessel 30, thus creating flow through 39 and into the hot water heater 40. In addition, valve Z2 may open and pump 46 may circulate water via line 48 into the solar thermal storage vessel 30, thus creating flow through connecting line 39, when water in the water heater 40 is heated above a threshold temperature in anticipation of a demand response event.

The water heater 40 includes an outlet line 42 that provides heated water to a heat exchanger 60 positioned within the supply duct/plenum 52 of a heat pump 50 at the premises. A return line 44 is provided from the heat exchanger 60 to the solar thermal storage vessel 30. The outlet line 42, the return line 44, and the diverter line 48 (described below) may be collectively referred to as a second water circulating system 45. A pump 46 in the second water circulating system 45 is used to pump heated water from the hot water heater 40 through the heat exchanger 60 within the supply duct/plenum 52 of the heat pump 50 and then back to the solar thermal storage vessel 30. Valve Z1 in the outlet line 42 of the second water circulating system 45 is used to control the flow of water from the hot water heater 40 to the heat exchanger 60. The primary purpose of valve Z1 is to prevent natural/convective circulation of hot water through the heat exchanger 60 in all modes other than when hot water heat is desired.

Valve Z2 is provided within a diverter line 48 between the outlet line 42 and the return line 44 and is used to divert water to the solar thermal storage vessel 30 when valve Z1 is closed. This allows the pump 46 to circulate heated water between the hot water heater 40 and the solar thermal storage vessel 30 so that the temperature of the water can be raised in both the hot water heater 40 and the solar thermal storage vessel 30.

A controller 70, which includes one or more processors, is utilized to control operation of the various pumps and valves (i.e., pumps 34, 46 and valves Z1, Z2) in the first and second water circulating systems 15, 45 to raise the temperature of the water in both the hot water heater 40 and the solar thermal storage tank above their respective normal setpoints and then cause the heated water to flow through the heat exchanger 60 in the supply duct/plenum 52 of the heat pump 50. As such, this heated water can substitute for the electric strip heating in the heat pump 50, thereby reducing the electricity demand of the heat pump 50. In the illustrated embodiment, a tempering valve 90 is provided to reduce the temperature of the domestic hot water (DHW) from the hot water heater 40. The tempering valve 90 is coupled with a cold water source to temper the hot water.

The controller 70 may be configured to monitor and/or receive weather forecast data for a future period of time (e.g., the next 12˜24 hours, etc.) and initiate a demand response (DR) mode of the system 10. For example, the controller 70 may be configured to monitor and/or receive weather forecast data via the internet and/or via a radio transmitter. As described above, DR mode drives the solar thermal storage vessel 30 and hot water heater 40 to elevated temps during off-peak time periods for use during on-peak utility time periods. For example, in response to weather forecast data, the controller 70 is configured to control operation of the second water circulating system 45 to cause water circulation between the water heater 40 and the solar thermal storage vessel 30 so as to raise the temperature of the water in the solar thermal storage vessel 30 and in the water heater 40 above their respective normal operation temperature set points. Water is circulated between the solar thermal storage vessel 30 and the water heater 40 by the heating pump 46 with valve Z1 closed and valve Z2 is open.

Embodiments of the present invention are designed to make sure there is maximum stored energy (i.e., heated water) for any type of anticipated DR event.

In some embodiments, the controller 70 may be configured to monitor and/or receive cloud cover and solar insolation forecast data for the area in which the residential or commercial premises is located and to determine whether time of use (TOU) charging would benefit system efficiency/cost. For example, the controller 70 may be configured to monitor and/or receive cloud cover and solar insolation forecast data via the internet and/or via a radio transmitter. TOU charging refers to a rate tariff where off peak consumption is billed at a discounted rate ($/kwh). Depending on how deep the TOU charging discount is, the control strategy of maximizing total stored water temperature (combined solar thermal storage vessel 30 and water heater 40) for use later during on-peak rates might offer an economic benefit (lower energy cost) for a customer. By way of input parameters during initial setup, such as Heat Pump COP (Coefficient of Performance)-(basic/standard efficiency ratings), TOU rates vs. on-peak rates and comfort setpoints, the controller 70 is configured to manage the system 10 for optimum performance as a function of existing or anticipated outdoor weather conditions.

As another example, in response to cloud cover and solar insolation forecast data, the controller 70 may be configured to control operation of the second water circulating system 45 to cause water circulation between the water heater 40 and the solar thermal storage vessel 30 so as to raise the temperature of the water in the solar thermal storage vessel 30 and in the water heater 40 above respective normal operation temperature set points. Water is circulated between the solar thermal storage vessel 30 and the water heater 40 by the heating pump 46 with valve Z1 closed and valve Z2 is open.

In some embodiments, the controller 70 monitors the balance point (BP) of the heat pump 50 by collecting thermostat set point vs. initiation of auxiliary strip heat at steady state vs. outdoor temperature (ODT)/wind speed. Steady state, as used herein, is when the heat pump 50 output at continuous duty (runs full time) meets or nearly meets the heat loss from the structure where only periodic/occasional addition of strip heat is required (thus, “initiation” of strip heat). This practically equates to the definition of balance point, i.e., heat input to structure=heat loss from structure, exactly. For any structure, the wind speed plays a roll due to increased structural heat loss, at the same outdoor temperature, due to convective heat transfer (loss) of the structure.

One or more algorithms executed by the controller 70 can determine whether to use auxiliary strip heating in the heat pump 50 or to use the thermal storage loop from the hot water heater 40 and solar thermal storage vessel 30 as function of outdoor temp below the balance point (BP) of the heat pump. If the controller 70 determines that the auxiliary strip heating in the heat pump 50 should be overridden, the controller 70 overrides the auxiliary heat strips in the heat pump 50 and causes the second water circulating system 45 to circulate heated water from the hot water heater 40 to the heat exchanger 60 to provide auxiliary heat for the heat pump 50.

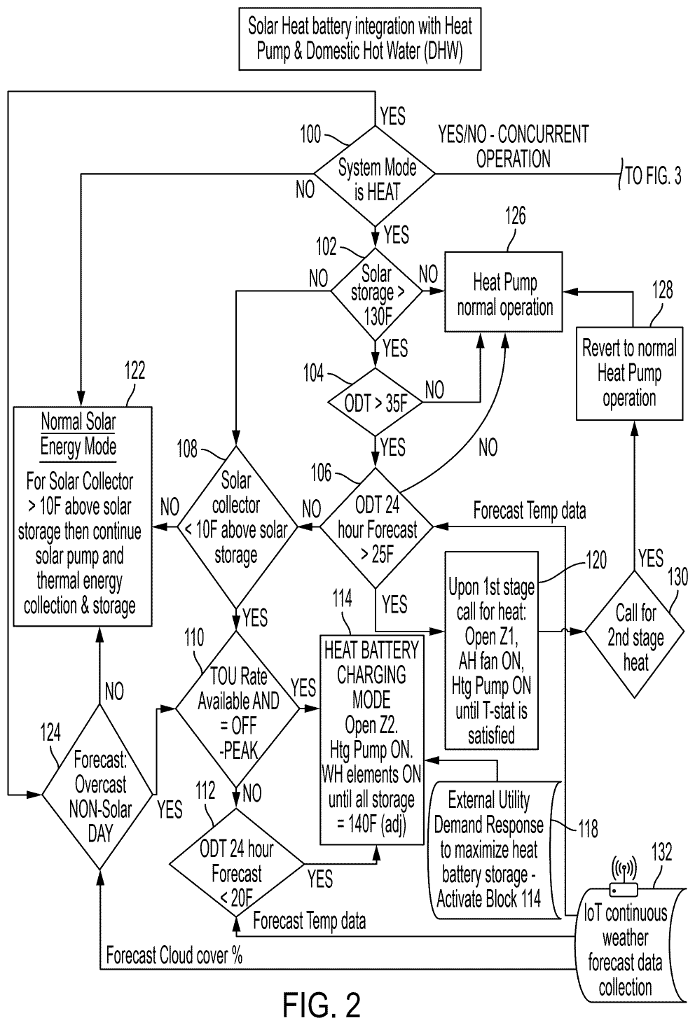

In some embodiments, the controller 70 may be configured to receive a signal from an electric utility to enter demand response (DR) mode in anticipation of electric grid strain (FIG. 2, Block 118). In response to receiving the signal, the controller 70 controls operation of the second water circulating system 45 to cause water circulation between the water heater 40 and the solar thermal storage vessel 30 so as to raise the temperature of the water in the solar thermal storage vessel 30 and in the water heater 40 above respective normal operation temperature set points. Water is circulated between the solar thermal storage vessel 30 and the water heater 40 by the heating pump 46 with valve Z1 closed and valve Z2 is open.

The controller 70 is configured to provide “field” setup/adjustment depending on connected electric utility TOU availability. The controller 70 will also have the ability to set a TOU window of time. Window of time, as applicable to TOU, is determined by an electric utility, possibly based on seasonality, when TOU rates are initiated and terminated. Seasonality might have different TOU windows of time relative to summer vs. winter, for example.

The controller 70 also provides accessibility for a user to set/adjust various configuration parameters of the system 10, such as temperature sensor setpoints of system components, water heater set point, outdoor air lockout temperature for strip heat (i.e., temperature above which strip heat is not allowed to operate), total storage set point for heat battery charging mode (FIG. 2, Block 114), solar thermal storage vessel 30 temperature value above water heater 40 at which water circulation between the solar thermal storage vessel 30 and the water heater 40 is activated.

The controller 70 may also have Wi-Fi connection capability with computer/smartphone interface capability. In addition, the controller 70 may also include on-board readout and menu/adjustment keys. For example, in some embodiments, the controller may have an interface with a digital display, an up/down rocker/toggle switch for selecting entry mode and parameter adjustment (setpoints), and a selection (enter/confirm) button.

A battery back up power supply 80 is also provided in the illustrated embodiment of system 10. The battery back up power supply 80 provides back up power to the heat pump blower, to the various pumps and valves (i.e., pumps 34, 46 and valves Z1, Z2) of the system 10 and to the controller 70. As such, during a power outage, the battery back up power supply 80 can run the system 10 and heat the residential or commercial premises utilizing stored hot water.

FIG. 2 is a flow diagram illustrating various operations of the system 10 of FIG. 1. Beginning at Block 100, a determination is made by the controller 70 if the heat pump 50 is in heat mode (i.e., supplying heat to the residential/commercial premises). If the answer is “Yes”, a determination is made at Block 102 by the controller 70 whether the water temperature in the solar thermal storage vessel 30 is greater than 130° F. or some other pre-set temperature. In addition, if the answer at Block 100 is “Yes”, a determination is made at Block 124 by the controller 70 whether there is a forecast for the present day as being overcast (i.e., a non-solar day). If the answer at Block 124 is “No” (i.e., the day is not forecast to be overcast), the controller 70 at Block 122 controls the solar thermal collector 20 operate in normal solar energy mode if the water temperature at the solar thermal collector 20 is hotter than the water in the solar thermal storage vessel 30 by more than 10° F. or some other pre-set temperature. Similarly, if the answer at Block 100 is “No”, the controller 70 controls the solar thermal collector 20 to operate in normal solar energy mode if the water temperature at the solar thermal collector 20 is hotter than the water in the solar thermal storage vessel 30 by more than 10° F. or some other pre-set temperature. If the answer at Block 124 is “Yes” (i.e., the day is forecast to be overcast), the controller 70 determines at Block 110 whether both of the following conditions are present: a) whether the local electric utility has TOU rate available, and b) whether system charging opportunity in Block 114 matches correct time of day so as to take advantage of TOU rates.

Returning to Block 102, if the answer at Block 102 is “Yes”, a determination is made at Block 104 by the controller 70 whether the ODT is greater than 35° F. or some other pre-set temperature. It is to be understood that this is a set point temperature that can be selectable during configuration of the controller 70. As such, the temperature in Block 104 can be different than 35° F. Moreover, all of the temperatures displayed in the various blocks of FIG. 2 can be different than what is illustrated, and can be selectable during configuration of the controller 70. Embodiments of the present invention are not limited to the temperatures displayed in the various blocks of FIG. 2.

If the answer at Block 102 is “No”, a determination is made at Block 108 by the controller 70 whether the water temperature at the solar thermal collector 20 is cooler than the water in the solar thermal storage vessel 30 by more than 10° F. or some other pre-set temperature. If the answer at Block 108 is “Yes”, the controller 70 determines at Block 110 whether both of the following conditions are present: a) whether the local electric utility has TOU rate available, and b) whether system charging opportunity in Block 114 matches correct time of day so as to take advantage of TOU rates. However, if the answer at Block 108 is “No”, the controller 70 at Block 122 controls the solar thermal collector 20 to operate in normal solar energy mode if the water temperature at the solar thermal collector 20 is hotter than the water in the solar thermal storage vessel 30 by more than 10° F. or some other pre-set temperature.

In addition, if the answer at Block 102 is “No”, normal operation of the heat pump 50 is maintained (Block 126) by the controller 70. Similarly, if the answer at Block 104 is “No”, normal operation of the heat pump 50 is maintained (Block 126) by the controller 70. If the answer at Block 104 is “Yes” (i.e., the ODT is greater than 35° F. or another preset temperature), a determination is made at Block 106 by the controller 70 if the ODT for the next twenty four hours is forecast to be greater than 25° F. or another pre-set temperature. If the answer is “Yes”, the controller 70 determines that a first stage call for heat exists and opens valve Z1, and turns the air handler (AH) fan and heat pump 50 on until the temperature set at the thermostat for the heat pump 50 is satisfied (Block 120). If the controller 70 determines that a call for second stage heat exists (Block 130) the controller reverts the heat pump 50 to normal operation (Block 128). If the answer at Block 106 is “No”, normal operation of the heat pump 50 is maintained (Block 126) by the controller 70. In addition, if the answer at Block 106 is “No”, a determination is made at Block 108 by the controller 70 whether the water temperature at the solar thermal collector 20 is cooler than the water in the solar thermal storage vessel 30 by more than 10° F. or some other pre-set temperature, as described above.

Returning to Block 110, if both conditions are met (i.e., whether the local electric utility has TOU rate available, and whether system charging opportunity in Block 114 matches correct time of day so as to take advantage of TOU rates), the controller 70 directs the system 10 to enter “Heat Battery Charging Mode” which causes valve Z2 to open, valve Z1 to close, and the water heater elements to heat the water in the water heater 40 until all water stored in the hot water heater 40 and the solar thermal storage vessel 30 is at a temperature of approximately 140° F. or another setpoint temperature configured during system setup. If the answer at Block 110 is “No”, the controller 70 determines whether the ODT forecast for the next twenty four hours is less than 20° F. or another pre-set temperature at Block 112. If the answer at Block 112 is “Yes”, the controller 70 directs the system 10 to enter “Heat Battery Charging Mode” (Block 114) which causes valve Z2 to open, valve Z1 to close, and the water heater elements to heat the water in the water heater 40 until all water stored in the hot water heater 40 and the solar thermal storage vessel 30 is at a temperature of approximately 140° F. or a setpoint temperature configured during system setup.

Block 132 in FIG. 2 is representative of an Internet-of-Things (IoT) device that continuously collects weather forecast data and provides this data to the controller 70 for use in the various decisions to be made at Blocks 124, 112 and 106. The IoT device includes WiFi reception functionality. Alternatively or in addition, the controller 70 may be designed (hard coded) to seek closest (valid) weather station via the internet for collection of current outdoor air temperature, future outdoor air temperature, cloud cover, and future (anticipated) cloud cover.

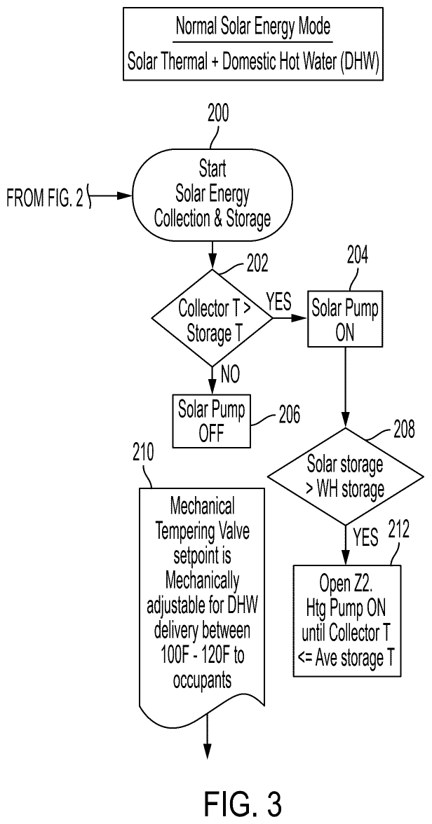

FIG. 3 is a flow diagram illustrating operations of the system 10 of FIG. 1 when in “Normal Solar Energy Mode” (i.e., FIG. 2, Block 122). Beginning at Block 200, the controller 70 directs the system 10 to start solar energy collection and storage. The controller 70 determines at Block 202 whether the water temperature in the solar thermal collector 20 is greater than the water temperature in the solar thermal storage vessel 30. If the answer is “Yes, the controller 70 turns on the solar pump 34 so that water circulation between the solar thermal collector 20 and the solar thermal storage vessel 30 begins so that the water temperature in the solar thermal storage vessel 30 can be raised. If the answer at Block 202 is “No, the controller 70 turns off the solar pump 34 (Block 206).

Once water circulation between the solar thermal collector 20 and the solar thermal storage vessel 30 begins, the controller 70 continuously determines if the temperature of the water in the solar thermal storage vessel 30 is greater than the temperature of the water in the water heater 40 (Block 208). If the answer is “Yes”, the controller opens valve Z2, closes valve Z1, and turns on the heating pump 46 to create water circulation between the water heater 40 and the solar thermal storage vessel 30. This circulation is continued until the water temperature in the solar thermal collector 20 is less than or equal to the average water storage temperature, i.e., the average water temperature between the water heater 40 and the solar thermal storage vessel 30 (Block 212).

The mechanical tempering valve 90 controls the temperature of the domestic hot water (DHW) that is made available to occupants of the residential/commercial premises.

The tempering valve 90 is configured to be mechanically adjustable so that the DHW temperature is typically between 100° F. and 120° F. (Block 210).

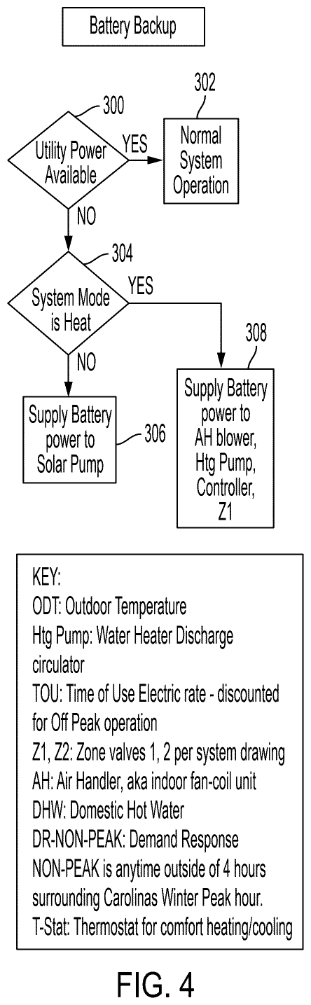

FIG. 4 is a flow diagram illustrating operations of the battery backup 80 for the system 10 of FIG. 1. Beginning at Block 300, the controller 70 determines if electric utility power is available to the system 10. If the answer is “Yes”, the system 10 is operated by the controller 70 in “Normal System Operation” mode (Block 302). If the answer at Block 300 is “No” (i.e., there is no electric utility power available to the system 10), the controller makes a determination at Block 304 if the system 10 is in “Heat Mode” (i.e., if the heat pump 50 was in “Heat Mode” prior to the loss of electric utility power). If the answer is “Yes”, the controller 70 receives power from the battery backup 80 then directs the battery backup 80 to supply power to the air handler fan in the heat pump 50, opens valve Z1, and turns on the heating pump 46 so that heated water from the hot water heater 40 is directed through the heat exchanger 60 within the supply duct/plenum of the heat pump 50 and so that heated air can be supplied to the residential/commercial premises as determined by the thermostat set point. If the answer at Block 304 is “No”, the controller 70 receives power from the battery backup 80 and directs the battery backup 80 to supply power to the solar pump 34 so that the water temperature in the solar thermal storage vessel 30 can be increased. In some embodiments, the controller 70 could conserve stored heat by reducing the thermostat set point five degrees (5°) lower until main power is restored.

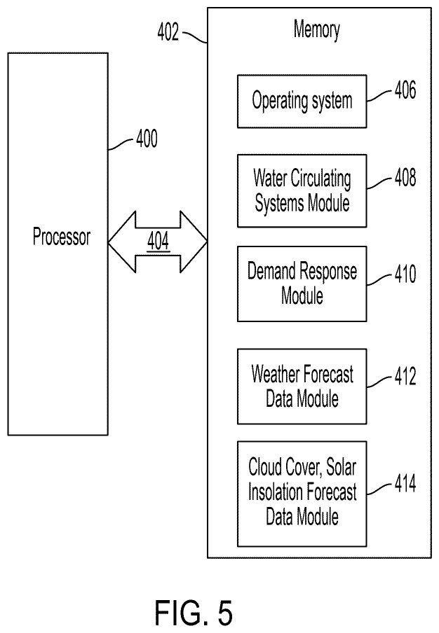

FIG. 5 is a block diagram that illustrates details of an exemplary processor(s) and memory that may be utilized to implement the controller 70 of the system of FIG. 1. The processor 400 communicates with the memory 402 via an address/data bus 404. The processor 400 may be, for example, a commercially available or custom microprocessor. The memory 402 is representative of the overall hierarchy of memory devices containing the software and data used to control and operate the system 10 as described herein, in accordance with some embodiments. The memory 402 may include, but is not limited to, the following types of devices: cache, ROM, PROM, EPROM, EEPROM, flash, SRAM, and DRAM.

As shown in FIG. 5, the memory 402 may hold various categories of software and data: an operating system 406, a water circulating systems module 408, a demand response module 410, a weather forecast data module 412, and a cloud cover, solar insolation forecast data module 414. The operating system 406 may coordinate execution of the various programs (e.g., the water circulating systems module 408, the demand response module 410, the weather forecast data module 412, and the cloud cover, solar insolation forecast data module 414, etc.) by the processor 400. The water circulating systems module 408 comprises logic for communicating with and controlling the various pumps and valves (i.e., pumps 34, 46 and valves Z1, Z2) in the first and second water circulating systems 15, 45 to raise the temperature of the water in both the hot water heater 40 and the solar thermal storage tank 30 above their normal setpoints and then cause the heated water to flow through the heat exchanger 60 in the supply duct/plenum 52 of the heat pump 50.

In addition, the water circulating systems module 408 comprises one or more algorithms executable by the controller 70 to determine whether to use auxiliary strip heating in the heat pump 50 or to use the thermal storage loop from the hot water heater 40 and solar thermal storage vessel 30 as function of outdoor temp below the balance point (BP) of the heat pump.

The demand response module 410 comprises logic for receiving a signal from an electric utility to enter demand response (DR) mode in anticipation of electric grid strain and then causing the system 10 to enter DR mode.

The weather forecast data module 412 comprises logic for monitoring and/or receiving weather forecast data for a future period of time via the internet and/or via a radio transmitter. The cloud cover, solar insolation forecast data module 414 comprises logic for monitoring and/or receiving cloud cover and solar insolation forecast data via the internet and/or via a radio transmitter.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity. The term “and/or” includes any and all combinations of one or more of the associated listed items.

Like numbers refer to like elements throughout. In the figures, certain components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected”, “coupled”, “responsive”, or variants thereof to another element, it can be directly connected, coupled or responsive to the other element or intervening elements may be present. In contrast, when an element is referred to as being “directly connected”, “directly coupled”, “directly response”, or variants thereof to another element, there are no intervening elements present. Other words used to describe the relationship between elements should be interpreted in a like fashion (i.e., “between” versus “directly between”, “adjacent”versus “directly adjacent”, etc.).

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,” which derives from the Latin phrase “exempli gratia,” may be used to introduce or specify a general example or examples of a previously mentioned item, and is not intended to be limiting of such item. The common abbreviation “i.e.,” which derives from the Latin phrase “id est,” may be used to specify a particular item from a more general recitation.

It will be understood that although the terms first, second, third, etc., may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of the present invention. The same reference numerals or the same reference designators denote the same or similar elements throughout the specification.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

As used herein, the singular forms “a”, “an” and “the” are intended to include the plural forms as well, unless the context clearly indicates otherwise. It will be further understood that the terms “comprises”, “comprising,” “includes” and/or “including” when used herein, specify the presence of stated features, operations, elements, and/or components, but do not preclude the presence or addition of one or more other features, operations, elements, components, and/or groups thereof.

The terms “about” and “approximately”, as used herein with respect to a value or number, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

What is claimed is:

1. A system for providing supplemental heating to a hot water heater and an electric heat pump at a residential or commercial premise, the system comprising:
a solar thermal collector;
a solar thermal storage vessel;
a first water circulating system operable to circulate water between the solar thermal storage vessel and the solar thermal collector, wherein the solar thermal collector is configured to transfer heat to the water circulating between the solar thermal storage vessel and the solar thermal collector in response to receiving solar radiation;
a second water circulating system operable to circulate heated water between the solar thermal storage vessel, the hot water heater, and a heat exchanger within an air supply duct associated with the heat pump; and
a controller operably associated with the first and second water circulating systems, the hot water heater, and the heat pump, wherein the controller is configured to control the second water circulating system to cause water circulation between the hot water heater and the solar thermal storage vessel so as to raise a temperature of water in the solar thermal storage vessel and/or in the hot water heater.

2. The system of claim 1, wherein the controller is further configured to control operation of the second water circulating system to cause water circulation between the hot water heater and the solar thermal storage vessel so as to raise the temperature of the water in the solar thermal storage vessel and/or in the hot water heater above their respective normal operation temperature set points.

3. The system of claim 1, wherein the heat pump comprises at least one auxiliary electric heat strip, and wherein the controller is further configured to override use of the at least one auxiliary heat strip by the heat pump and to cause the second water circulating system to circulate heated water from the hot water heater to the heat exchanger to provide auxiliary heat for the heat pump.

4. The system of claim 3, wherein the controller is configured to override use of the at least one auxiliary heat strip based on how far outdoor temperature at the premise is below a balance point of the heat pump.

5. The system of claim 1, wherein the controller is further configured to monitor and/or receive weather forecast data for a location of the residential or commercial premise and, in response to the weather forecast data, control operation of the second water circulating system to cause water circulation between the hot water heater and the solar thermal storage vessel so as to raise the temperature of the water in the solar thermal storage vessel and in the hot water heater above their respective normal operation temperature set points.

6. The system of claim 1, wherein the controller is further configured to monitor and/or receive cloud cover and solar insolation data for a location of the residential or commercial premise and, in response to the cloud cover and solar insolation data, control operation of the second water circulating system to cause water circulation between the hot water heater and the solar thermal storage vessel so as to raise the temperature of the water in the solar thermal storage vessel and in the hot water heater above their respective normal operation temperature set points.

7. The system of claim 1, wherein the controller is further configured to receive a signal from an electric utility to enter demand response mode in anticipation of electric grid strain and, in response to receiving the signal, control operation of the second water circulating system to cause water circulation between the water heater and the solar thermal storage vessel so as to raise the temperature of the water in the solar thermal storage vessel and in the water heater above respective normal operation temperature set points.

8. The system of claim 1, wherein the first water circulating system comprises a first pump configured to circulate the water between the solar thermal storage vessel and the solar thermal collector, wherein the second water circulating system comprises a second pump and first and second valves, wherein when the first valve is open and the second valve is closed, the water is circulated by the second pump between the hot water heater and the heat exchanger in the heat pump, and wherein when the first valve is closed and the second valve is open, the water is circulated by the second pump between the hot water heater and the solar thermal storage vessel.

9. The system of claim 8, further comprising a battery backup system configured to supply power to the first and second pumps, to the first and second valves, to the controller, and to an air handling unit of the heat pump.

10. A method of providing supplemental heating to a hot water heater and an electric heat pump at a residential or commercial premise, the premise including a solar thermal collector, a solar thermal storage vessel, a first water circulating system operable to circulate water between the solar thermal storage vessel and the solar thermal collector, a second water circulating system operable to circulate heated water between the solar thermal storage vessel, the hot water heater, and a heat exchanger within an air supply duct associated with the heat pump, and a controller operably associated with the first and second water circulating systems, the hot water heater, and the heat pump, the method comprising:
controlling the second water circulating system, via the controller, to cause water circulation between the hot water heater and the solar thermal storage vessel so as to raise a temperature of water in the solar thermal storage vessel and/or in the hot water heater above their respective normal operation temperature set points.

11. The method of claim 10, wherein the heat pump comprises at least one auxiliary electric heat strip, and wherein during use of the heat pump the method further comprises overriding, via the controller, use of the at least one auxiliary heat strip by the heat pump and causing the second water circulating system to circulate heated water from the hot water heater to the heat exchanger to provide auxiliary heat for the heat pump.

12. The method of claim 11, wherein the second water circulating system comprises a second pump and first and second valves, and wherein causing the second water circulating system to circulate heated water from the hot water heater to the heat exchanger to provide auxiliary heat for the heat pump comprises the following steps performed by the controller: opening the first valve, closing the second valve, and activating the second pump to cause circulation of heated water between the hot water heater and the heat exchanger in the heat pump.

13. The method of claim 10, further comprising:
monitoring or receiving weather forecast data for a location of the residential or commercial premise; and
in response to the weather forecast data, controlling operation of the second water circulating system, via the controller, to cause water circulation between the hot water heater and the solar thermal storage vessel so as to raise the temperature of the water in the solar thermal storage vessel and in the hot water heater above their respective normal operation temperature set points.

14. The method of claim 10, further comprising:
monitoring or receiving cloud cover and solar insolation data for a location of the residential or commercial premise; and
in response to the cloud cover and solar insolation data, controlling operation of the second water circulating system, via the controller, to cause water circulation between the hot water heater and the solar thermal storage vessel so as to raise the temperature of the water in the solar thermal storage vessel and in the hot water heater above their respective normal operation temperature set points.

15. The method of claim 10, further comprising:
receiving at the controller a signal from an electric utility to enter a demand response mode; and
in response to receiving the signal, controlling operation of the second water circulating system, via the controller, to cause water circulation between the hot water heater and the solar thermal storage vessel so as to raise the temperature of the water in the solar thermal storage vessel and in the hot water heater above their respective normal operation temperature set points.

16. A system for providing supplemental heating to a hot water heater and an electric heat pump at a residential or commercial premise, the system comprising:
a solar thermal collector;
a solar thermal storage vessel;
a first water circulating system operable to circulate water between the solar thermal storage vessel and the solar thermal collector, wherein the solar thermal collector is configured to transfer heat to the water circulating between the solar thermal storage vessel and the solar thermal collector in response to receiving solar radiation;
a second water circulating system operable to circulate heated water between the solar thermal storage vessel, the hot water heater, and a heat exchanger within an air supply duct associated with the heat pump; and
a controller operably associated with the first and second water circulating systems, the hot water heater, and the heat pump, wherein the controller is configured to receive a signal from an electric utility to enter demand response mode in anticipation of electric grid strain and, in response to receiving the signal, control operation of the second water circulating system to cause water circulation between the hot water heater and the solar thermal storage vessel so as to raise the temperature of the water in the solar thermal storage vessel and in the hot water heater above their respective normal operation temperature set points.

17. The system of claim 16, wherein the heat pump comprises at least one auxiliary electric heat strip, and wherein the controller is further configured to override use of the at least one auxiliary heat strip by the heat pump and to cause the second water circulating system to circulate heated water from the hot water heater to the heat exchanger to provide auxiliary heat for the heat pump.

18. The system of claim 16, wherein the controller is further configured to monitor and/or receive weather forecast data for a location of the residential or commercial premise and, in response to the weather forecast data, control operation of the second water circulating system to cause water circulation between the hot water heater and the solar thermal storage vessel so as to raise the temperature of the water in the solar thermal storage vessel and in the hot water heater above their respective normal operation temperature set points.

19. The system of claim 16, wherein the controller is further configured to monitor and/or receive cloud cover and solar insolation data for a location of the residential or commercial premise and, in response to the cloud cover and solar insolation data, control operation of the second water circulating system to cause water circulation between the hot water heater and the solar thermal storage vessel so as to raise the temperature of the water in the solar thermal storage vessel and in the hot water heater above their respective normal operation temperature set points.

20. The system of claim 16, further comprising a battery backup system configured to supply power to the first and second pumps, to the first and second valves, to the controller, and to an air handling unit of the heat pump.
